(19) United States
(12) Patent Application Publication
(10) Pub. No.: US 2026/0098519 A1
(43) Pub. Date: Apr. 9, 2026

(54) TRANSPORTING WIND TURBINE COMPONENTS

(71) Applicant: Vestas Wind Systems A/S, Aarhus N. (DK)

(72) Inventors: Thomas Riis Jakobsen, Veile Øst (DK); Rasmus Sanderhoff Johansen, Hørning (DK); Jacob Christophersen, Juelsminde (DK); Emanuel Videira Monteiro, Porto (DK)

(73) Assignee: Vestas Wind Systems A/S, Aarhus N. (DK)

(21) Appl. No.: 19/113,960

(22) PCT Filed: Sep. 21, 2023
(86) PCT No.: PCT/DK2023/050225

§ 371 Date: Mar. 21, 2025

(30) Foreign Application Priority Data
Sep. 26, 2022 (DK) PA202270463

(51) Int. Cl. F03D 13/40; B65D 88/12; B65D 90/00

(52) U.S. Cl. CPC F03D 13/402; B65D 88/129; B65D 90/0026; F05B 2260/02

(57) ABSTRACT

A transport structure (42) for transporting a set of wind turbine components (22) on a vehicle (92, 94). The transport structure (42) comprises: a support structure (44), comprising at least one frame (46); and a set of locking interfaces arranged on the support structure (44) for releasably securing the transport structure (42) when in transit. Said at least one frame (46) comprises attachment means configured for releasably securing at least one wind turbine component (22) of the set of wind turbine components to said at least one frame (46).

### TECHNICAL FIELD

The invention relates to transporting wind turbine components on vehicles, and particularly transporting wind turbine components overseas.

### BACKGROUND TO THE INVENTION

As wind turbines become progressively larger to exploit economies and efficiencies of scale, transportation of wind turbine components to installation sites becomes correspondingly more challenging.

A particular challenge may arise for multiple stage journeys involving different transportation modes, for example where the components are shipped overseas and then taken on from a receiving port by road or by rail to the ultimate destination.

Typically, goods to be shipped are packed in ISO standardised shipping containers, or ‘intermodal containers’, which can be handled effectively at ports, packed efficiently and securely on a ship and then transferred to a second compatible vehicle, such as a lorry or a train car, at the receiving port for a second stage of travel.

However, whereas a 40-foot ISO container, for example, is specified with a maximum gross mass of 36 tonnes and may be shipped with that load, a lower weight limit may apply for the second stage of travel. For example, in the US a maximum load of 19 tonnes applies for road travel using a vehicle having a triaxle chassis. In addition, harbour cranes at the receiving port may not have sufficient capacity to lift a container that is packed to the maximum gross mass.

In principle, this can be addressed by removing and repacking some of the contents of a container at the receiving port, to reduce the weight to within the limit for the harbour cranes and/or the second transportation mode. However, this generates additional work at the port and also necessitates an additional container for the removed contents.

It is therefore often preferred to pack the shipping container to an initial weight that is within the capacity of the harbour cranes and all vehicles involved in completing the journey to the ultimate destination. This allows the container to be transferred directly from the ship to the second vehicle and therefore optimises the time in the receiving port. A drawback to this solution is that it entails shipping a container that is only partially full, thus wasting capacity on the ship.

A related challenge arises from the standardised nature of shipping containers, which inherently constrain the dimensions of the components to be transported. For example, in a common configuration an ISO container has a length of 40 feet, which therefore places a corresponding limit on the length of components to be packed into the container. Since many wind turbine components are large scale and elongate in nature, this length constraint can become relevant and impact the design of the components.

Packing heavy, elongate components into a container may also be difficult in practical terms. For example, pushing such elements horizontally through the front opening of a standard container requires sufficient space in front of the container, and relies on the availability of handling equipment capable of manoeuvring the component in this manner. For this reason, ISO open-topped containers or ISO flat rack containers may be preferred for transporting wind turbine components, since these can be loaded from above. However, such containers are typically heavier than corresponding closed containers to provide the required strength in an open structure, and so further impact the total weight of the components that can be carried in a single container.

It is against this background that the invention has been devised.

### SUMMARY OF THE INVENTION

An aspect of the invention provides a transport structure for transporting a set of wind turbine components on a vehicle, including land, air and seagoing vehicles. The transport structure comprises: a support structure, comprising at least one frame; and a set of locking interfaces arranged on the support structure for releasably securing the transport structure when in transit, for example securing the structure to the vehicle and/or to other transport structures such as ISO shipping containers. Said at least one frame comprises attachment means configured for releasably securing at least one wind turbine component of the set of wind turbine components to said at least one frame.

The transport structure may comprise at least two transport modules that each supports one or more of the components of the set, in use, each module comprising a set of co-operating module-to-module locks configured for releasably interconnecting the at least two modules, to form and divide the transport structure. The transport structure is therefore modular in such embodiments. This beneficially allows the structure to be transported on one journey as a complete structure where weight restrictions allow, and then the structure can be divided into its constituent modules for a later journey where a lower weight limit applies. This optimises usage of the structure and avoids wasting capacity.

Conveniently, the module-to-module locks may comprise corner castings, allowing the modules to be connected and separated readily and quickly using standard equipment such as twist-lock interfaces.

At least one module may comprise multiple frames, each frame being configured to support a respective component of the set. The frames may define sub-frames of an overall frame defined by the frames collectively, which overall frame may in turn define the support structure. For example, the frames may be stacked to form the associated module and/or the overall frame. Similarly, the modules may be stacked when assembled. The frames may comprise releasable couplings for securing the frames together to form the associated module. The releasable couplings optionally comprise corner castings and so may connect using twist-lock interfaces.

The transport structure may comprise at least one frame that comprises a pair of orthogonal frame members coupled together, and optionally two pairs of parallel frame members arranged in a rectangular formation. Such a frame provides support in orthogonal directions and thus braces the support structure.

The transport structure may comprise at least one frame configured such that a component of the set defines a frame member of the frame. For that component defining a frame member, parallel frame members of the associated frame may be fixed at opposed ends of the component. Using the component as a frame member beneficially reduces the number of additional structural elements required and thus reduces the weight of the transport structure.

The transport structure may comprise a set of wind turbine components fixed to the support structure. In such embodiments, the components form part of the transport structure, and may act as frame members within the structure for example. Each component may act as a load-bearing element of the transport structure. In such embodiments, the components may predominantly bear horizontal loads. Using the components as load-bearing elements of the transport structure reduces the number of additional structural elements required to support the components and to form the structure, thereby minimising the weight of the support structure and, in turn, maximising the overall weight of components that can be carried in the transport structure. Each component may be fixed at opposed ends of the transport structure so that the component extends longitudinally through the structure.

The locking interfaces may be configured to interface with corresponding interfaces of, or for, a standard shipping container, for example an ISO shipping container of any size and configuration. Each locking interface may comprise a corner casting, which castings may match those of ISO containers, for example. The transport structure may have a shape and dimensions corresponding to a standard shipping container, for example an ISO shipping container of any size and configuration. The transport structure may therefore be configured to be used in the same way as a standard container, to the extent that the transport structure may be compatible for locking to corresponding standard containers and/or to interfaces on a vessel for receiving standard containers. Also, the transport structure may occupy the same envelope as a standard container and thus can be stacked with standard containers.

The wind turbine components of the set may all be of a similar size, and may be similar to one another. Alternatively, the structure may be configured to hold a mixture of different types of components. The set of wind turbine components may comprise a set of tower segments. The set of wind turbine components may comprise a set of cooling system components such as radiators, for example of the type that are mounted on a nacelle roof, which may be referred to as ‘cooler tops’.

Another aspect of the invention provides a method of transporting a set of wind turbine components on a vehicle. The method comprises forming a transport structure by fixing the components to a support structure. The support structure supports a set of locking interfaces for securing the transport structure in transit. The method may further comprise transporting the transport structure on a vehicle, including land, air and seagoing vehicles.

The method may comprise mounting each component to a respective frame, or to a respective set of frame members to form a respective frame, and coupling the frames together to form the structure. The frames may be coupled using a twist lock interface. The method may comprise twisting the lock interface in a first direction for a pair of frames that will form part of a common transport module of the transport structure, and twisting the lock interface in a second direction for a pair of frames that will belong to different transport modules of the transport structure.

The method may comprise transporting the transport structure on a vehicle, and then dividing the transport structure into multiple transport modules. The transport modules may then be transported onwards on separate vehicles. For example, the transport structure may be transported on a ship and then, once the structure is divided, the transport modules may be transported on separate road vehicles and/or train cars. In general terms, the transport structure may be transported on a vehicle having a relatively high load capacity, and the transport modules may be transported separately on vehicles having relatively low load capacities.

It will be appreciated that preferred and/or optional features of each aspect of the invention may be incorporated alone or in appropriate combination in the other aspects of the invention also.

### BRIEF DESCRIPTION OF THE DRAWINGS

So that it may be more fully understood, the invention will now be described, by way of example only, with reference to the accompanying drawings, in which like features are assigned like reference numbers, and in which:

FIG. 1 is a schematic view of a wind turbine;

FIG. 2 shows a tower segment of the tower of the wind turbine of FIG. 1 in perspective view;

FIG. 3 shows a known iso shipping container;

FIGS. 4 to 6 show views of a corner casting of the container of FIG. 3;

FIG. 7 shows, in perspective view, a transport structure for transporting a set of the tower segments of FIG. 2;

FIG. 8 shows the transport structure of FIG. 7 in side view;

FIG. 9 shows an exploded view of the transport structure of FIG. 7;

FIGS. 10 and 11 show an intermediate frame of the transport structure of FIG. 7 in perspective and side views;

FIGS. 12 and 13 show a frame assembly of the intermediate frame of FIGS. 10 and 11 in front and rear perspective views;

FIG. 14 shows in perspective view a base frame of the transport structure of FIG. 7 supporting the tower segment of FIG. 2;

FIG. 15 corresponds to FIG. 14 but shows the base frame without the tower segment;

FIG. 16 corresponds to FIG. 15 but shows the base frame from the side;

FIG. 17 shows a detail view of a locking interface of the transport structure of FIG. 7;

FIG. 18 shows the transport module of FIG. 7 in transit on a ship;

FIG. 19 shows a transport module of the transport structure of FIG. 7 in transit on a road vehicle;

FIG. 20 shows a perspective view of an alternative transport structure;

FIG. 21 shows a transport module of the transport structure of FIG. 20;

FIG. 22 shows a perspective view of another alternative transport structure;

FIG. 23 shows a transport module of the transport structure of FIG. 22;

FIG. 24 shows a schematic perspective view of a transport structure for transporting a set of cooling tops; and

FIG. 25 shows a schematic perspective view of an alternative transport structure for transporting a set of cooling tops.

### DETAILED DESCRIPTION OF EMBODIMENTS OF THE INVENTION

In general terms, embodiments of the invention provide transport structures for transporting wind turbine components by air, land or sea on vehicles such as ships, trains and lorries. The structures may be configured to emulate the shape and dimensions of ISO standard shipping containers such that the structure can be handled and packed in the same manner as a standard container. This also creates opportunities to transport the structure using a container liner, namely a seagoing vessel that transports only ISO containers. The structures can be configured to emulate any ISO container size.

The structure is provided with locking interfaces for securing the structure in transit. The locking interfaces may be compatible with those of standard shipping containers so that the structure can be secured to a vehicle and/or to other structures or containers in the same way as a standard container. Indeed, the locking interface may include corner castings and twist lock interfaces that are identical to those found on standard containers.

The transport structure can be tailored to the components that the structure is intended to transport, and may be configured such that the components form part of the structure. This may relieve constraints on the dimensions of the components relative to using a standard closed container. The components may even act as frame members or other load bearing elements within the structure, reducing the number of additional structural elements required and thereby minimising the overall weight of the structure in transit, in turn increasing the total weight of components that may be transported by a single structure.

In some embodiments the transport structure is modular, in the sense that the structure is made up of two or more transport modules that can be assembled to form the structure and disassembled to divide the structure when desired. For example, the structure may be transported as a whole on a ship and then divided into its constituent modules at the receiving port, so that each module can be carried by a separate road or rail vehicle for the next stage of travel. This beneficially allows the total capacity of the structure to exceed a weight limit that applies to the second stage of travel, while each module is within that weight limit. This, in turn, means that the structure can be fully loaded for an initial stage of travel on the ship to avoid wasting capacity on the ship, and then divided at the receiving port to meet the requirements of the next stage of the journey.

The transport modules may be secured together using reversible locking interfaces, such as twist-lock interfaces already used in ISO containers, allowing the structure to be connected into the structure or divided into modules quickly and without specialist equipment. Dividing the structure therefore has a significantly smaller impact on the time spent at a receiving port compared to situations in which a standard container must be repacked.

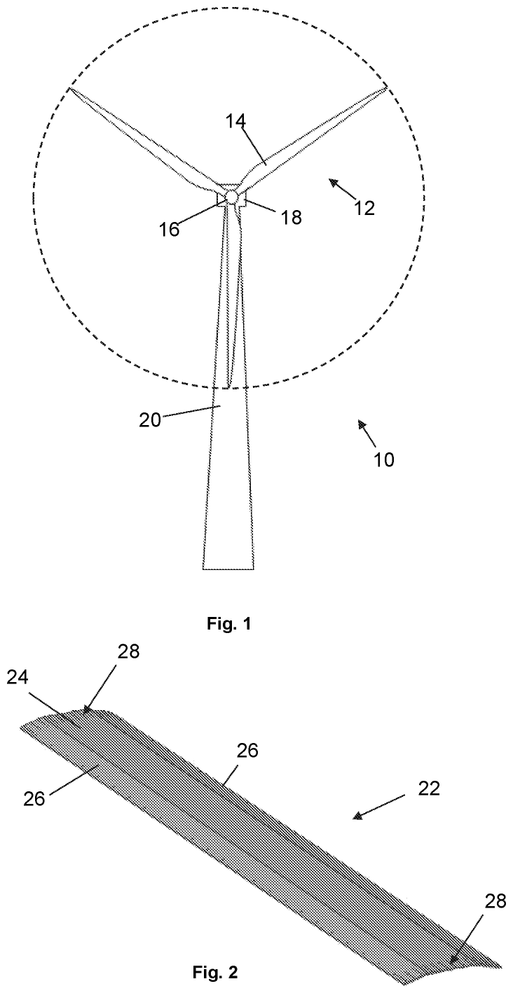

To provide context for the invention, FIG. 1 shows an individual wind turbine 10 whose components may be transported using transport structures according to the invention. It should be appreciated that the wind turbine 10 of FIG. 1 is referred to here by way of example only.

The wind turbine 10 shown in FIG. 1 is a three-bladed upwind horizontal-axis wind turbine (HAWT), which is the most common type of turbine in use. The wind turbine 10 comprises a rotor 12 having three blades 14 extending radially from, and equi-angularly spaced around, a central hub 16. It is noted that although three blades are common, different numbers of blades may be used in alternative implementations. The rotor 12 is supported by its hub 16 at the front of a nacelle 18, which in turn is mounted at the top of a support tower 20 that is secured to a foundation (not shown) that is embedded in the ground.

The nacelle 18 contains a generator that is driven by the rotor 12 to produce electrical energy. Thus, the wind turbine 10 is able to generate electrical power from a flow of wind passing through the swept area of the rotor 12 causing rotation of the blades 14. In this respect, the blades 14 cover a circular swept area that is represented in FIG. 1 by a dashed circle encompassing the tips of the blades 14. The nacelle 18 also contains components of a cooling system used to maintain desired component temperatures when the wind turbine 10 is in operation.

The wind turbine 10 is utility-scale and so, for example, may have blades that are 100 metres or more in length. The tower 20 is correspondingly longer, for example over 150 meters in length. Transporting the tower 20 in its finished form may therefore not be practical.

Accordingly, in some approaches the tower 20 may be segmented, in that the tower 20 is formed from an assembly of tower segments that can be transported separately and then assembled on-site. FIG. 2 shows an example of such a tower segment 22, which has the general form of an elongate plate having two mutually spaced longitudinal folds dividing the plate into three planar sections in this example, defining a central face 24 flanked on each side by an edge face 26, which faces will become facets of the tower 20. In other examples, segments may include two or more planar sections. The edge faces 26 are approximately half the width of the central face 24 and are inclined at a shallow angle relative to the central face 24, such that the segment 22 effectively curves transversely around a longitudinal axis corresponding to the central axis of the assembled tower 20.

A longitudinal series of holes extends along each side edge of the segment 22 at regular intervals. These holes allow the segment 22 to be coupled to similar segments 22 along each side edge. In this embodiment, coupling eight such segments 22 together in this way forms a ring that will define a portion of the tower 20, although the number of segments required to form a ring may vary in other examples, for example between six and fifteen segments, depending on the configuration of the segments.

Similarly, perforated end regions 28 are defined at each end of the segment 22, in which regions 28 the segment 22 comprises two-dimensional arrays of holes. These end regions 28 interface with corresponding end regions of longitudinally adjacent segments 22 to allow coupling of those segments 22. Thus, each completed ring of segments 22 can be coupled end-to-end to another such ring, to form a stack of rings that in turn define the tower 20.

The tower segment 22 therefore defines a part-shell of a portion of the tower 20, being arranged to couple to similar segments 22 along each side and at each end to form an upwardly tapering frustoconical shell defining the tower 20.

The configuration of the tower 20 and its segments 22 is not the subject of this disclosure and so further details are omitted for clarity.

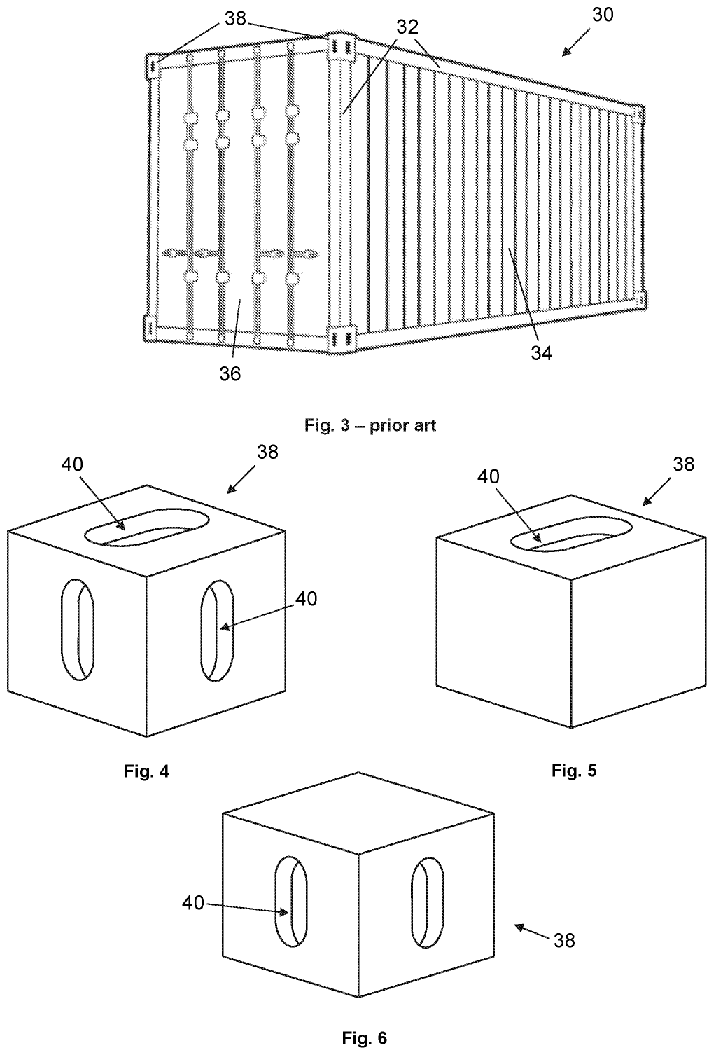

To transport the tower segments 22 to the installation site, the segments 22 could be packed into an ISO container 30 such as that shown in FIG. 3. More specifically, FIG. 3 shows a standard 40-foot ISO high cube container. The container 30 has a frame comprising a set of frame members 32 in a box formation, corrugated panels 34 extending between the frame members 32 to enclose an interior of the container 30, and a door 36 covering a front opening allowing access to the interior. Corner castings 38 are arranged at each corner of the frame to allow the container 30 to be secured to a vehicle such as a vessel, truck or train car, and/or to other containers, using twist-lock interfaces.

FIGS. 4 to 6 show front, rear and bottom views respectively of a corner casting 38 of the container 30, revealing that the casting 38 has the form of a hollow cuboid block having central elongate slots 40 on three neighbouring sides. The remaining three sides are solid and uninterrupted. The slots 40 are arranged to align with corresponding slots 40 in a locking interface of a vehicle or a casting 38 of another container, and to receive a locking member that extends through both slots 40 and is shaped to be retained in the slots 40 when rotated, to secure the casting 38 in place.

It is noted that the corner castings 38 of the container 30 are not all configured in the same way, and instead the slots differ to account for the position of the casting 38 on the container 30 as is conventional. In particular, castings 38 on top corners of the container 30 differ from castings 38 on bottom corners.

If the tower segments 22 are to be transported in the container 30 of FIG. 3, the segments 22 will need to be sized accordingly. In particular, the length and width of each segment 22 must allow for the segment 22 to be received inside the container 30. The dimensions of the segments 22, in turn, dictates the number of segments 22 into which the tower 20 must be divided for a tower of given proportions.

Once the segments 22 have been designed to fit inside an ISO container 30, the number of segments 22 that can be packed into a single container may be limited by the resulting weight of the packed container. In particular, if the container 30 is to be carried by rail or by road for part of its journey, the associated weight limits will typically entail that the number of segments 22 that can be loaded into a container 30 is fewer than the space of the container 30 would allow for, leading to wasted space in the container 30.

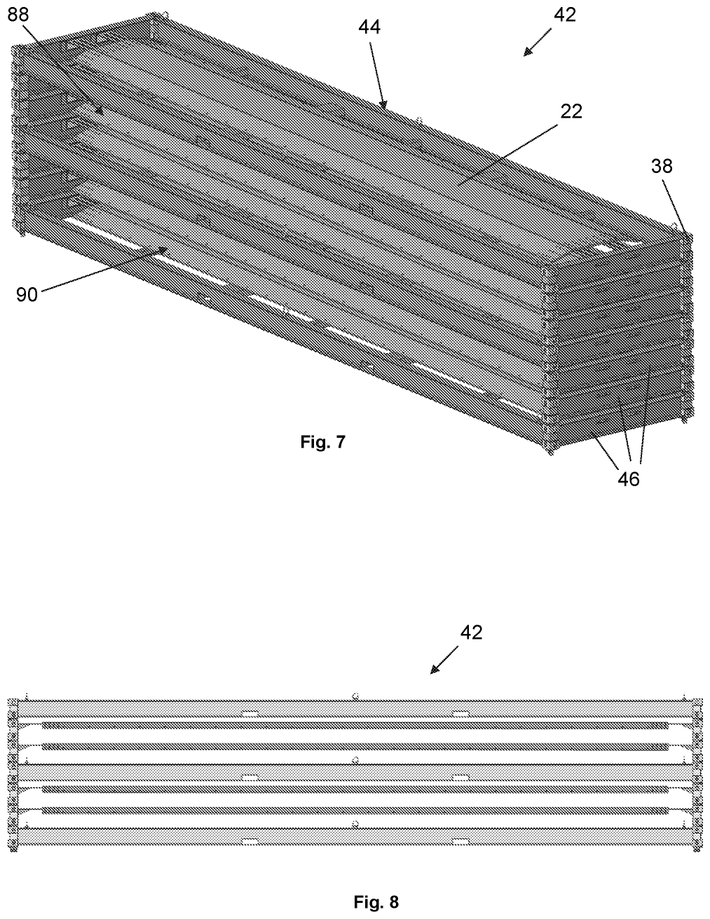

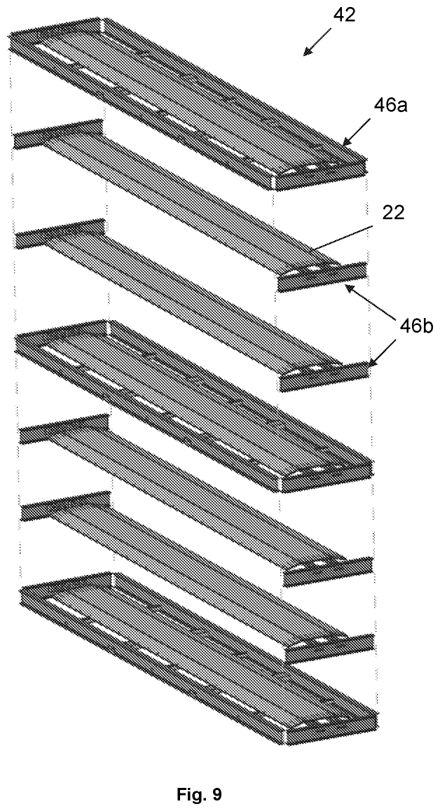

In this context, FIGS. 7 to 9 show a transport structure 42 that provides an alternative means of transporting a set of tower segments 22. As best seen in the exploded view of FIG. 9, the transport structure carries seven of the tower segments 22 shown in FIG. 2, although in other examples transport structures may be configured to carry different numbers of components.

As FIG. 7 shows best, the transport structure 42 has the same outer shape and dimensions as the standard container 30 of FIG. 3. Accordingly, the transport structure 42 can be handled and packed on a vehicle as if it were a container 30 such as shown in FIG. 3. Moreover, each corner of the transport structure 42 is furnished with a corner casting 38 matching the casting 38 at the corresponding corner of the standard container 30, both in structure and position. This allows the transport structure 42 to be secured to a vehicle and/or to other structures or containers in the same way as the standard container 30.

The transport structure 42 comprises a support structure 44 to which the tower segments 22 are mounted and fixed. Accordingly, unlike the standard container 30 of FIG. 3, the segments 22 form part of the transport structure 42. Indeed, as shall become clear from the description that follows, some of the tower segments 22 act to some extent as load bearing elements of the structure 42. This reduces demands on the support structure 44, enabling the support structure 44 to become more lightweight.

The support structure 44 comprises a stack of seven generally oblong frames 46 of similar proportions, each supporting a respective one of the tower segments 22 so that the segments 22 extend longitudinally through the transport structure 42 in parallel with each other, at regular vertical intervals.

The frames 46 secure to one another to form the support structure 44, which may alternatively be regarded as an overall frame composed of a stack of sub-frames, each frame 46 representing a sub-frame. In this example, as FIG. 9 shows, the frames 46 comprise three base frames 46a and four intermediate frames 46b, arranged such that two pairs of intermediate frames 46b are sandwiched between base frames 46a disposed at the top, bottom and centre of the stack.

In contrast with the standard container 30 of FIG. 3, the support structure 44 of the transport structure 42 has an open construction, such that the segments 22 within are visible. The open construction of the transport structure 42, in turn, reduces the combined mass of the structural elements and thus allows for an increased mass of transported components compared with the standard container 30. It is noted, however, that the transport structure 42 could optionally be enshrouded by a lightweight protective cover when in transit.

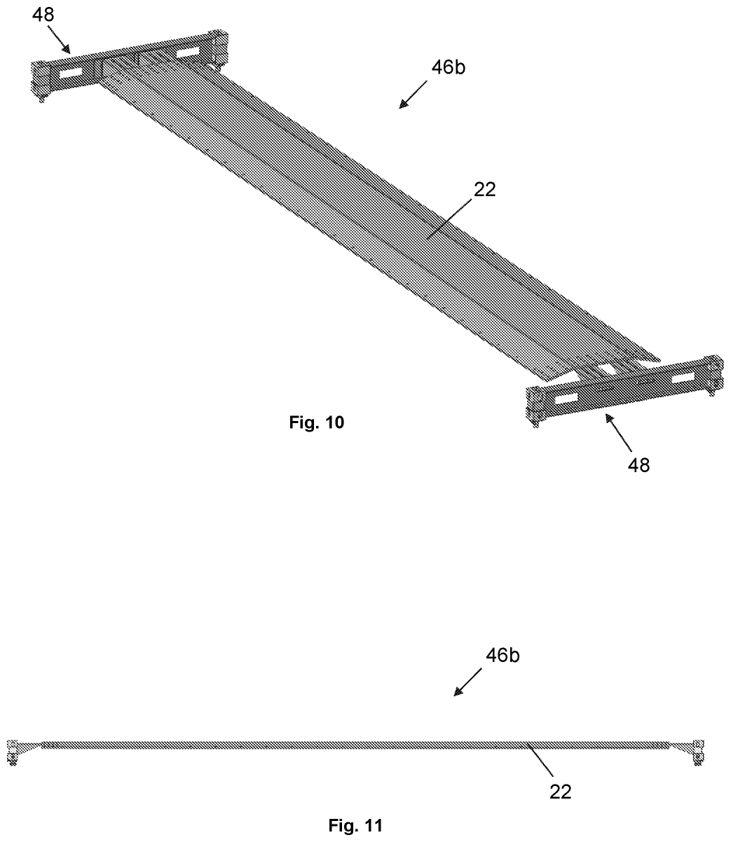

An intermediate frame 46b is shown in isolation in FIGS. 10 and 11, and is composed of a pair of spaced, parallel frame assemblies 48 arranged at opposed ends of a tower segment 22. Each frame assembly 48 is fixed to, and supported relative to the opposite frame assembly 48 by, its respective end of the tower segment 22. Accordingly, the tower segment 22 defines a frame member of the intermediate frame 46b. The frame assemblies 48, in turn, couple to neighbouring frames 46 to integrate the intermediate frame 46b into the transport structure 42.

When assembled in the transport structure 42, vertical support for the frame assemblies 48 is provided by the other frames 46 of the support structure 44. Meanwhile, the tower segment 22 of the intermediate frame 46b contributes some horizontal support to the intermediate frame 46b, and thus alleviates the need for additional horizontal elements. In this way, using the tower segment 22 as a frame member in the intermediate frame 46b reduces the weight of structural elements in the support structure 44. Conversely, the stresses applied to the tower segment 22 in use are relatively low as the frame assemblies 48 are also held in place when assembled in the transport structure 42 by virtue of being fixed to adjacent frames 46 of the stack.

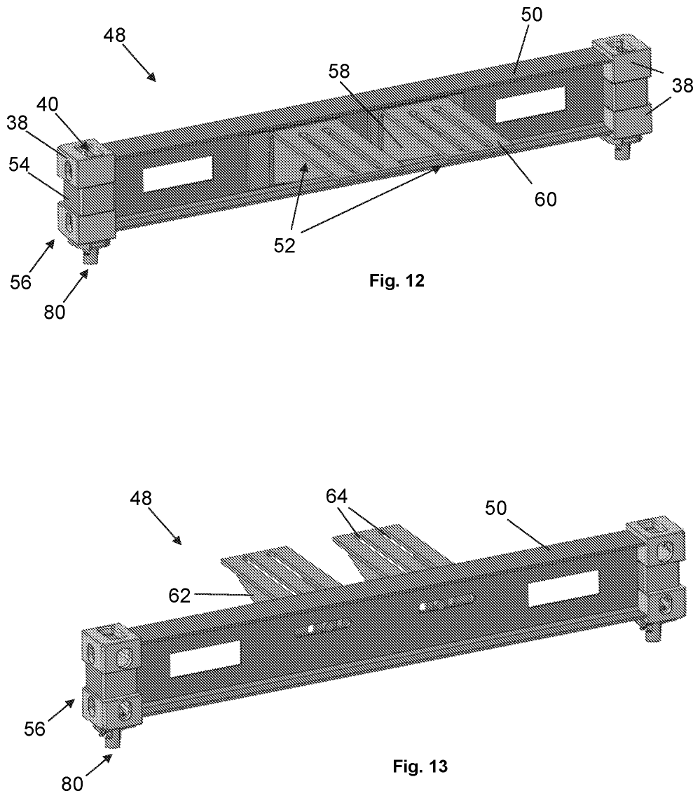

As FIGS. 12 and 13 show, each frame assembly 48 comprises a beam member 50 in the form of a steel I-beam, a pair of corner castings 38 mounted at each end of the beam member 50, and a pair of L-shaped mounting brackets 52 fixed to a side of the beam member 50, to either side of a centre of the beam member 50.

The beam members 50 are of a length corresponding to the width of the transport structure 42, and are arranged parallel to one another and in longitudinal alignment, such that their respective corners are positioned to coincide with corners of an oblong profile of the transport structure 42. The beam members 50 include oblong apertures for weight saving purposes in this example.

Each pair of corner castings 38 is supported by an end mount 54 that is disposed between the castings 38 to form a corner assembly 56. The end mount 54 of each corner assembly 56 is fixed to a respective end of the beam member 50, for example by welding, so that one corner casting 38 aligns with an upper end of the beam member 50, and the remaining corner casting 38 aligns with a lower end of the beam member 50. Each corner casting 38 is oriented such that its slots 40 are disposed on faces directed out from the intermediate frame 46b. So, for example, the upper corner casting 38 is oriented with its slots 40 on its upper face and on the outer side faces that face away from the tower segment 22. Each corner casting 38 is therefore arranged to interface with corresponding corner castings 38 of frames 46 above and below the intermediate frame 46b in the stack, when assembled.

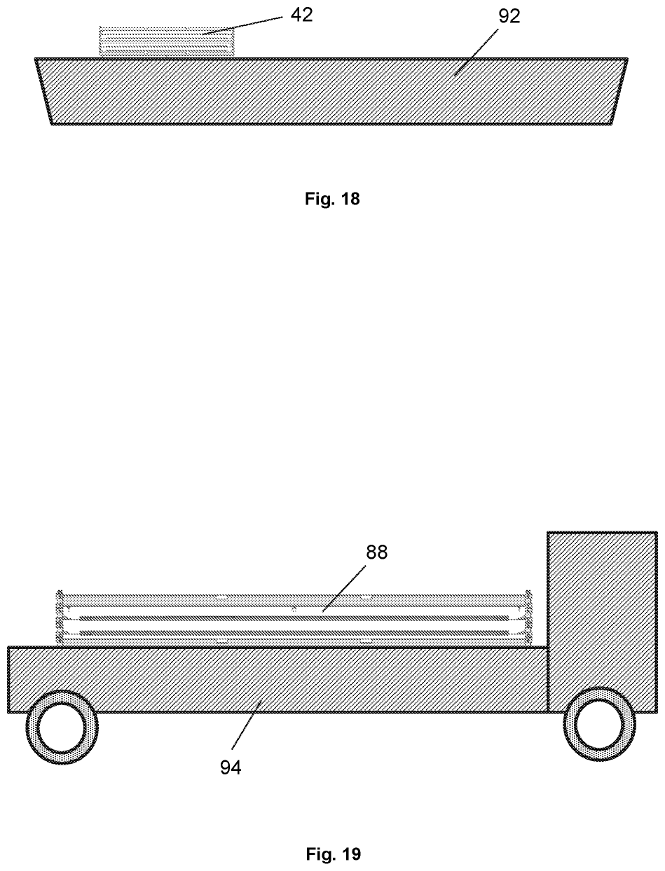

The corner castings 38 match those used in standard containers and in the corners of the transport structure 42, to form part of standard twist-lock interfaces allowing for the frames 46 to be connected and disconnected. This interface is shown in FIG. 17 and described in more detail later.

Each mounting bracket 52 is formed from a steel plate that is bent through a right angle to create a base portion 58 and a mounting flange 60. The base portion 58 fixes to a side face of the beam member 50 and thus extends in a vertical plane, and is oriented so that the mounting flange 60 extends from an upper end of the base portion 58, orthogonally to the side face of the beam member 50. As FIG. 13 shows, each mounting bracket 52 is also provided with a triangular brace plate 62 extending between, and orthogonal to, the base portion 58 and the mounting flange 60, to add strength to the bracket 52.

The mounting brackets 52 are arranged on the beam member 50 such that the respective mounting flanges 60 align in a common plane, and the frame assemblies 48 are in mirror relation such that their respective mounting flanges 60 extend toward one another to form a pair of spaced mounts between which the tower segment 22 can rest. The mounting flanges 60 include slots 64 that cooperate with the holes in the end regions 28 of the tower segment 22, to enable the segment 22 to be fixed to the mounting brackets 52, and in turn the frame assemblies 48, using suitable fixings. Accordingly, the mounting flanges 60 provide attachment means for releasably securing a wind turbine component, namely the tower segment 22, to the associated frame 46.

It is noted that the configuration of the mounting brackets 52 is merely an example, and frame assemblies 48 may be configured and fixed to the tower segment 22 in any suitable way.

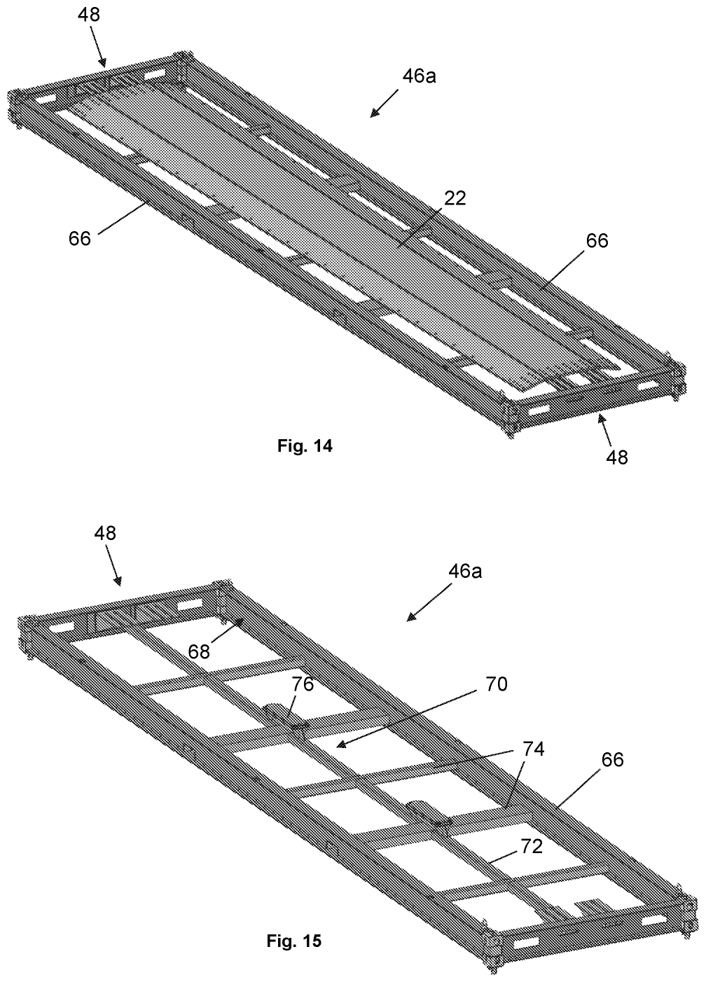

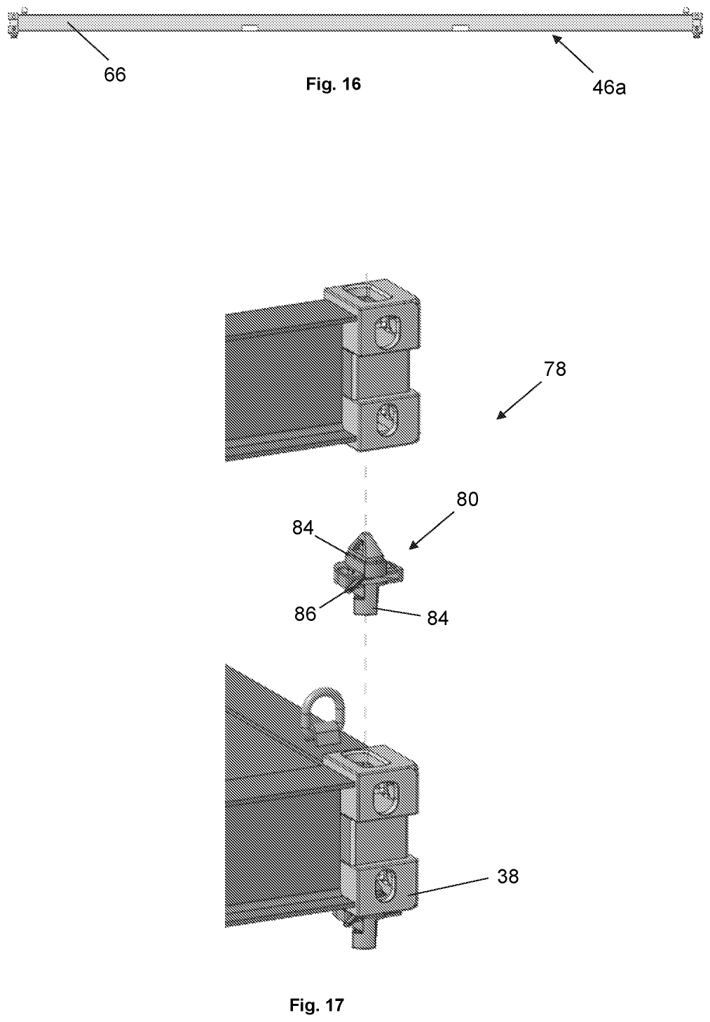

Turning now to FIGS. 14 to 16, a base frame 46a is shown. The base frame 46a comprises a pair of frame assemblies 48 matching those of the intermediate frame 46b. However, whereas the frame assemblies 48 are connected by the tower segment 22 in the intermediate frame 46b, the base frame 46a comprises a pair of mutually-parallel longitudinal frame members 66 that connect the frame assemblies 48 at the corners, so that the longitudinal frame members 66 and the beam members 50 of the frame assemblies 48 form a closed outer frame 68 having an oblong profile corresponding to the profile of the transport structure 42.

The longitudinal frame members 66 are defined by steel I-beams of the same cross section as the beam members 50 of the frame assemblies 48. The length of the longitudinal frame members 66 is such that the frame assemblies 48 are fixed relative to one another at the same spacing as in the intermediate frame 46b, so that the respective frame assemblies 48 of the intermediate and base frames 46 align when stacked.

The base frame 46a also includes an inner frame 70 that resides within and braces the outer frame 68. The inner frame 70 comprises a central longitudinal strut 72 extending between the beam members 50 of the frame assemblies 48, beneath the mounting flanges 60, and a series of regularly-spaced lateral struts 74 that extend between the longitudinal frame members 66 and therefore cross the longitudinal strut 72. The struts 72, 74 of the inner frame 70 may be welded together, for example, and in turn the inner frame 70 may be welded to the outer frame 68.

Accordingly, by virtue of its inner and outer frames 68, 70 the base frame 46a is rigid and robust, and in turn imparts rigidity to the transport structure 42.

FIG. 14 shows that a tower segment 22 can be mounted between the opposed mounting flanges 60 of the base frame 46a in the same way as in the intermediate frame 46b, although in the base frame 46a the segment 22 does not define a frame member or bear any significant loads, since the base frame 46a is a self-supporting unit. This is made clearest in FIG. 15, which shows the base frame 46a without the segment 22 attached.

FIG. 15 also shows dunnage 76 placed in spaced positions on the inner frame 70, to provide additional support to the tower segment 22 and to damp vibration of the segment 22 when in transit. In this example, the dunnage 76 comprises blocks of PUR (polyurethane), although other materials may also be useful, as may inflated bags or other deformable bodies. It should be appreciated that dunnage may be placed in various positions throughout the transport structure 42 to support the tower segments 22 as may be required.

It is noted that the base frame 46a and the intermediate frame 46b each allow more space for the tower segment 22 longitudinally than the standard container 30 of FIG. 3, by eliminating the need for doors and side panels and by supporting the segments 22 directly using the support structure 44. In contrast, when using the standard container 30 a separate support frame may be required inside the container 30 to hold the tower segments 22 securely, which requires additional space and adds weight. Accordingly, the transport structure 42 allows the tower segments 22 to be manufactured at a greater length than for the case where the segments 22 are transported in a standard container 30. This, in turn, reduces the total number of segments 22 required to form the tower 20.

By way of example, the transport structure 42 of FIG. 7 has an overall length of 12.2 metres to correspond to the 40-foot container 30 of FIG. 3, which has been found to allow for a tower segment 22 of up to 11.8 meters in length. The segments 22 shown in the present example are 10.98 meters in length, however.

As noted above, FIG. 17 shows a twist-lock interface 78 of the transport structure 42, and specifically an interface between respective corners of a base frame 46a and an intermediate frame 46b to lock the corners of the two frames 46 together. It should be appreciated that similar locking interfaces are provided between each of the other corners of the frames 46 shown, and between the corresponding corners of each other pair of frames 46 within the structure 42.

The twist-lock interface 78 comprises a pair of corner castings 38, each belonging to a respective frame 46, and a locking member in the form of a conventional twistlock 80. The twistlock 80 comprises a central body 82 supporting upper and lower male connectors 84, the connectors 84 extending in opposed directions from the body 82 and being rotatable relative to the body 82 using a lever 86 extending from the body 82. In FIG. 17, the upper male connector 84 is shaped to be received inside a slot 40 in a lower face of the corner casting 38 of the intermediate frame 46b, and the lower male connector 84 is received inside a slot 40 in an upper face of the corner casting 38 of the base frame 46a. The slots 40 and their associated castings 38 therefore represent female connectors of the interface 78. When the frames 46 are brought together, the central body 82 of the twistlock 80 is interposed between the respective corner castings 38 of the intermediate and base frames 46 and so holds the frames 46 slightly apart.

Each male connector 84 has an outer profile to complement, although not necessarily match, that of the slot 40 in which it is received, that profile being oval or otherwise non-circular to define side projections or lobes that hold the connector 84 captive in the casting 38 when it is rotated by 90°.

It is noted that it is also possible for a twistlock 80 to be integrated with or built into a corner casting 38, for example by welding the twistlock 80 to the casting 38. In this case, the corner casting 38 comprising the twistlock 80 comprises an outwardly projecting male connector 84 that can be received by a corresponding corner casting 38 of a neighbouring frame 46, and only this male connector 84 need be rotated and thus locked to secure the frame corners together. Alternatively, an integrated twistlock 80 may define a female connector for receiving a male connector of an adjacent frame.

It is noted that the vehicles that will transport the transport structure 42 include similar twist-lock interfaces 78, specifically a set of twistlocks protruding upwardly from a floor or deck of the vehicle that receive the corner castings 38 of the bottom frame 46 of the structure 42. Once mounted to the vehicle, the vehicle itself may contribute some strength to the structure to the extent that the corners of the bottom base frame 46a are fixed in position.

It will be apparent from the above that the frames 46 can be connected and divided in any combination. In the example shown in FIG. 7, the upper two base frames 46a and the intervening pair of intermediate frames 46b are intended to form part of a first transport module 88, and the lower base frame 46a and the lower pair of intermediate frames 46b form part of a second transport module 90. The first and second transport modules 88, 90 are therefore stacked when assembled into the transport structure 42 in this example, and as such are arranged to be divided in a horizontal plane when splitting the structure 42 into its constituent modules 88, 90. Accordingly, the transport structure 42 is modular.

As FIGS. 18 and 19 show, in use the first and second transport modules 88, 90 may initially be connected to form the full transport structure 42, so that the transport structure 42 can be transported as a whole on a ship 92. Then, when the ship 92 reaches a receiving port, the transport structure 42 can be divided into the first and second modules 88, 90 so that each module 88, 90 can be loaded onto a separate road vehicle 94 for onward travel. FIG. 19 shows the first transport module 88 on a road vehicle 94, and it will be appreciated that the second transport module 90 is loaded onto a separate road vehicle.

In the scenario depicted in FIGS. 18 and 19, the total weight of the transport structure 42 exceeds the capacity of the road vehicles 94, and so the ability to divide the structure 42 into modules 88, 90 allows the full capacity of the transport structure 42 to be utilised in the first stage of the journey on the ship 92.

The locking interfaces 78 that connect the first and second modules 88, 90 together therefore define module-to-module locks, which are intended to be operated when switching transportation modes. The remaining locking interfaces 78 that connect the frames 46 within each module 88, 90, while also being releasable couplings, are not intended to be operated during the journey to the ultimate destination for the components.

To aid with ensuring that the structure 42 is divided correctly at the receiving port, it is envisaged that the twist-lock interfaces 78 may be arranged such that it is apparent which are to be operated. For example, interfaces 78 connecting the upper intermediate frame 46b of the second transport module and the lower base frame 46a of the first transport module 88, which must be unlocked to divide the modules 88, 90, may be oriented with the respective levers 86 facing outwardly such that they are readily accessible. The remaining twist-lock interfaces 78 between frames 46 that are not to be divided can be oriented with the respective levers 86 facing in the opposite direction, and therefore into the structure 42, such that they are harder to access and therefore less likely to be unlocked unintentionally.

As each frame 46 uses the same corner castings 38, the frames 46 are interchangeable and so the transport structure 42 may be reconfigured in various ways. Typically, each transport module of the structure 42 is provided with at least one base frame 46a to provide rigidity to the module when divided. It is possible for all of the frames 46 of a structure to be base frames 46a for increased strength and versatility, noting that such a structure could be divided into modules in various different ways to suit the requirements of different journeys.

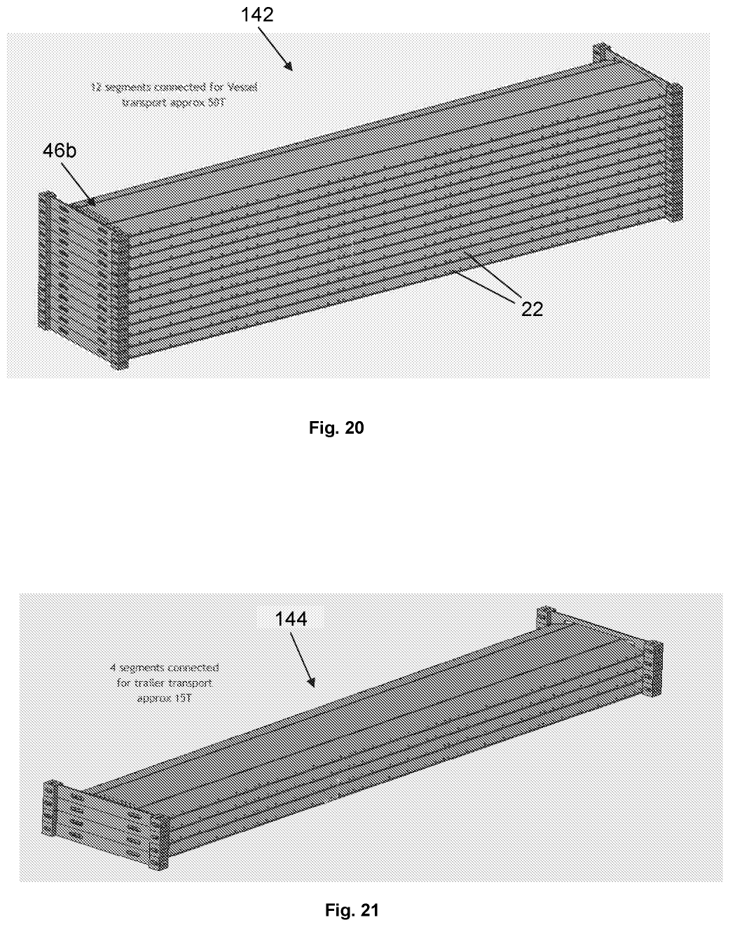

FIGS. 20 and 21 show another possibility in this respect, in which a transport structure 142 is composed entirely of intermediate frames 46b identical to those of the example shown in FIG. 10. Accordingly, the transport structure 142 of FIGS. 20 and 21 largely relies on the tower segments 22 for horizontal strength, although as noted above the vehicle itself can contribute horizontal support when the structure 142 is fixed to the vehicle in transit.

The structure 142 shown in FIG. 20 includes twelve frames 46, each supporting a respective tower segment 22 as in the previous example. The transport structure 142 can be divided into modules, in this case three modules 144 each having four frames 46, and FIG. 21 shows one such module 144. The structure 142 could be divided into modules in different ways.

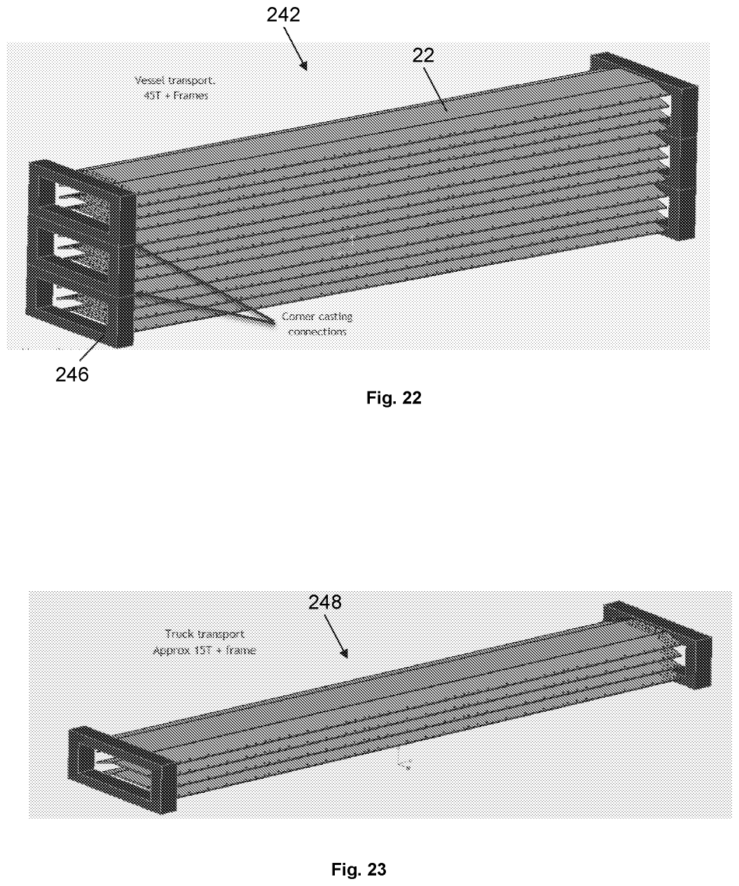

FIGS. 22 and 23 show another example of a modular transport structure 242 for tower segments 22. In this example, the segments 22 are not supported on individual frames 46 as in the previous examples. Instead, the structure 242 comprises a stack of three rectangular end frames 246 at each end, each frame 246 supporting four segments 22 that are mounted to the frames 246 in any suitable manner. The frames 246 comprise corner castings 38 as in the previous examples, allowing the structure 242 to be secured to a vehicle and also allowing the frames 246 to be disconnected and divided into transport modules. FIG. 23 shows one such transport module 248, which has a single frame 246 at each end and supports four segments 22.

More generally, the frames can be configured in any suitable way to provide the desired modularity whilst enabling the tower segments 22 to be fixed to the support structure defined by the frames.

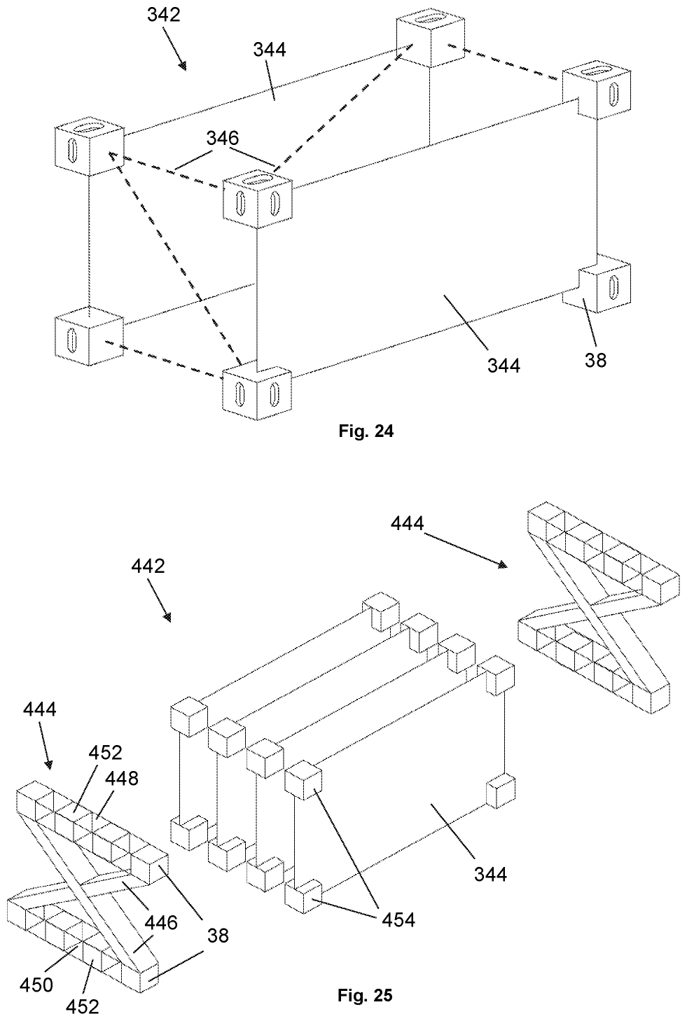

Moreover, transport structures can be adapted to support various other types of components, and need not be modular. Examples of this are shown in FIGS. 24 and 25, which are now described.

FIG. 24 shows a transport structure 342 for transporting a set of components of the cooling system of the wind turbine 10 of FIG. 1, specifically a pair of cooler frames, or ‘cooler tops’ 344. In this respect, the cooler tops 344 comprise rectangular frames that can be dimensioned appropriately to serve as frames of the transport structure 342 during transit. To create the transport structure 342, corner castings 38 are fixed to each corner of each cooler top 344, for example by welding, to enable the transport structure 342 to be secured to vehicles and/or to other transport structures, whether similar transport structures or standard containers.

Structural beams defining frame members 346 are fixed between the corner castings 38 to hold them relative to one another. In this example, lateral frame members 346 are fitted between each pair of corresponding corners of the cooler tops, and further frame members 346 are fitted to extend diagonally across the structure 342. The specific positions of the frame members 346 shown in FIG. 24 are illustrative only, and frame members 346 can be positioned to suit the requirements of each application. The frame members 346 collectively form a frame around or between the cooler tops 344 that hold the cooler tops in place relative to one another, so that the cooler tops 344 and the frame together define the transport structure 342. It follows that, in this example, the corner castings 38 define attachment means for releasably securing the cooler tops 344 to the frame defined by the frame members 346.

As in the previous examples, the transport structure 342 can be configured with the same shape and dimensions as a standard ISO container 30 such as that shown in FIG. 3.

Finally, FIG. 25 shows another transport structure 442 for transporting a set of cooler tops 344, in this example a set of four cooler tops 344 similar to those of the preceding example. The structure 442 is shown in a disassembled state in FIG. 25. The transport structure 442 comprises a pair of frames 444 that are arranged at each end of the structure 442 and fix to the end corners of each of the cooler tops 344.

Each frame 444 comprises four corner castings 38 arranged in a rectangle, which will become the corners of the transport structure 442 and thereby enable the structure 442 to be secured, as in the other examples.

A pair of frame members 446 extend between diagonally opposed corner castings 38, the frame members 446 therefore crossing one another. A further pair of frame members extend parallel to one another, including an upper frame member 448 extending between the upper pair of corner castings 38, and a lower frame 450 member extending between the lower pair of corner castings 38. Each of the upper and lower frame members 448, 450 carries two couplings 452, represented as blocks in FIG. 25, that are disposed between the associated corner castings 38 so that the castings 38 and the couplings 452 are at regular spacings, the couplings 452 of the upper frame member 448 being in vertical alignment with corresponding couplings 452 of the lower frame member 450.

Each cooler top 344 is provided with a coupling 454 at each corner, these couplings 454 again being represented as blocks in FIG. 25. Each coupling 454 is configured to couple to a corresponding coupling 452 or corner casting 38 of the associated end frame 444. So, the front and rear cooler tops 344 shown in FIG. 25 are provided with couplings 454 for securing to the corner castings 38 of each of the frames 444, whereas the middle pair of cooler tops 344 are provided with couplings 454 complementing those of the upper and lower frame members 448, 450 of the frames 444.

The frames 444 can therefore be secured to the cooler tops 344 at each end by engaging the relevant couplings 452, 454, thereby forming the transport structure 442. Again, the transport structure 442 has a shape and dimensions corresponding to a standard ISO container 30 such as that shown in FIG. 3.

The couplings 452, 454 shown in FIG. 25 may be of any suitable kind, and may be standard corner castings 38.

The structures 342, 442 shown in FIGS. 24 and 25 provide similar benefits to that of FIG. 7 in terms of allowing for the components that are to be transported, in this case the cooler tops 344, to be larger than if they were to be packed inside a standard shipping container 30. Also, the weight of the frames of the structures is relatively low, in turn increasing the combined weight of the components that can be transported.

While the structures shown in FIGS. 24 and 25 are not configured as modular, it should be appreciated that these structures can be adapted to become modular if required. For example, the frames of the structure 442 shown in FIG. 25 could be divided to have two interlocking frames at each end of the structure, allowing for the structure to be split into modules in a similar manner to the structure of FIG. 7 to accommodate the limitations of different transportation modes.

The skilled person will appreciate that modifications may be made to the specific embodiments described above without departing from the inventive concept as defined by the claims.

For example, although the transport structures described above are configured to divide in horizontal planes to separate the constituent transport modules, in other examples transport modules could be connected side by side, for example using bridge fittings and vertical twist locks, to form a transport structure that can be divided in one or more vertical planes.

More generally, it is emphasised that the structures described above are examples only, and transport structures may be configured in any suitable way to transport a variety of different wind turbine components. In some examples, a transport structure may be configured to hold a mixture of different types of components. In each case, a suitable support structure comprising one or more frames is provided to support and secure the components in transit.

Although conventional twist-lock interfaces are used in the above examples, transport structures may use any other suitable locking interfaces.

1. A transport structure for transporting a set of wind turbine components on a vehicle, the transport structure comprising:
a support structure, comprising at least one frame; and
a set of locking interfaces arranged on the support structure for releasably securing the transport structure when in transit;
wherein said at least one frame comprises attachment means configured for releasably securing at least one wind turbine component of the set of wind turbine components to said at least one frame.

2. The transport structure of claim 1, comprising at least two transport modules that each supports one or more of the components of the set, in use, each module comprising a set of co-operating module-to-module locks configured for releasably interconnecting the at least two modules, to form and divide the transport structure.

3. The transport structure of claim 2, wherein the module-to-module locks comprise corner castings.

4. The transport structure of claim 1, wherein at least one module comprises multiple frames, each frame being configured to support a respective component of the set.

5. The transport structure of claim 4, wherein the frames are stacked to form the associated module.

6. The transport structure of claim 4, wherein the frames comprise releasable couplings for securing the frames together to form the associated module.

7. The transport structure of claim 6, wherein the releasable couplings comprise corner castings.

8. The transport structure of claim 1, comprising at least one frame that comprises a pair of orthogonal frame members coupled together.

9. The transport structure of claim 1, comprising at least one frame configured such that a component of the set defines a frame member of the frame.

10. The transport structure of claim 9, wherein parallel frame members of the associated frame are fixed at opposed ends of the component defining a frame member.

11. The transport structure of claim 1, comprising a set of wind turbine components fixed to the support structure.

12. The transport structure of claim 11, wherein each component acts as a load-bearing element of the transport structure.

13. The transport structure of claim 11, wherein each component is fixed at opposed ends of the transport structure.

14. The transport structure of claim 1, wherein the locking interfaces are configured to interface with corresponding interfaces of, or for, a standard shipping container.

15. The transport structure of claim 1, wherein each locking interface comprises a corner casting.

16. The transport structure of claim 1, having a shape and dimensions corresponding to a standard shipping container.

17. The transport structure of claim 1, wherein the set of wind turbine components comprises a set of tower segments.

18. The transport structure of claim 1, wherein the set of wind turbine components comprises a set of cooler tops.

19. A method of transporting a set of wind turbine components, the method comprising forming a transport structure by fixing the components to a support structure, wherein the support structure supports a set of locking interfaces for securing the transport structure in transit.

20. The method of claim 19, comprising mounting each component to a respective frame, or to a respective set of frame members to form a respective frame, and coupling the frames together to form the structure.

21. The method of claim 20, comprising coupling the frames using a twist lock interface.

22. The method of claim 21, comprising twisting the lock interface in a first direction for a pair of frames that will form part of a common transport module of the transport structure, and twisting the lock interface in a second direction for a pair of frames that will belong to different transport modules of the transport structure.

23. The method of claim 19, comprising transporting the transport structure on a vehicle, and then dividing the transport structure into multiple transport modules.

24. The method of claim 23, comprising transporting the transport modules onwards on separate vehicles.
